(19) United States
(12) Patent Application Publication
(10) Pub. No.: US 2007/0242459 A1
(43) Pub. Date: Oct. 18, 2007

(54) Backlight system, liquid crystal display including the same, and method of adjusting backlight

(75) Inventor: Eitaro Nishigaki, Kanagawa (JP)

Correspondence Address: YOUNG & THOMPSON, 745 SOUTH 23RD STREET, 2ND FLOOR, ARLINGTON, VA, 22202, US

(73) Assignee: NEC LCD TECHNOLOGIES, LTD., KANAGAWA (JP)

(21) Appl. No.: 11/783,804

(22) Filed: Apr. 12, 2007

(30) Foreign Application Priority Data
Apr. 14, 2006 (JP) 2006-111982

(51) Int. Cl. F21V 23/04

(52) U.S. Cl. 362/276; 362/97

(57) ABSTRACT

A photosensor section is disposed in a vicinity of the center of a shorter side of an LED panel including plural arrays of LED units in each of which plural LEDs are arranged. A gain of the photosensor section is adjusted on the basis of gain correction information set in advance according to the position of each LED unit. Thereby, the calibration of the photosensor section is performed. While the photosensor section, which has been adjusted in this manner, sequentially detects the amounts of light from the LED units, a backlight unit emits backlight toward a liquid crystal display panel.

### BACKGROUND OF THE INVENTION

1. Field of the Invention

The present invention relates to a backlight system, a liquid crystal display device including the backlight system, and a method of adjusting a backlight.

2. Description of the Related Art

A liquid crystal display (LCD) device has features of a small size, a thin shape and low power consumption. For this reason, an LCD device has been widely used for office automation (OA) equipment, audio and visual (AV) equipment, a portable terminal device or the like. The LCD device is provided with a backlight source at the back side of an LCD panel. In the LCD device, an image is displayed by controlling the transmission of light emitted from the backlight source by using liquid crystal layer. As the backlight source, a fluorescent lamp is generally used. However, peripheral circuits such as an inverter are required for turning on the fluorescent lamp, and such an inverter generates noise. For these reasons, a light emitting diode (LED) has been recently used as the backlight source.

When a moving image is displayed using an LCD device, an after image is generated in apart where there has been a movement in the image, owing to the response speed of liquid crystal layer. This brings about a problem of deterioration in the display quality. To prevent this after image from being generated, uses is a method in which all the LEDs are turned off once or more during the period of one field (hereinafter, referred to as the field period), so that the screen is darkened. Specifically, in this method, the following operations are repeated. During a period for which an image composed of one of RGB is written, all the LEDs are turned off. Then, during a period for which the image composed of one of RGB has been written and is retained, the LEDs of the corresponding color are turned on. This method can prevent the after image from being generated. However, a period for which the LEDs emit light becomes shorter in the field period than otherwise. This leads to a problem that the display becomes dark, as compared with the case where all the LEDs are constantly on.

In order to solve the above-described problem, a method has been proposed in which parts of an LED group are sequentially turned off. In this method, while an LCD panel is divided into plural areas, the LEDs are also divided into plural groups which correspond respectively to the areas of the LCD. In this method, when images are sequentially written in the plural areas of the LCD panel, the LEDs in the area which corresponds to the area of the LCD panel in a response transition period are turned off. In this way, the after image can be prevented from being generated by turning off the LEDs in the area corresponding to the area of the LCD panel in a response transition period. At the same time, by turning on the LEDs in the other areas, a bright display can be obtained.

However, the light emitting characteristics of LEDs and the amount of light emitted from the LEDs are not constant, and change with time. For this reason, in the method in which parts of LEDs are sequentially turned off, the luminance of the LEDs becomes low during a period for which LEDs having the low intensity of light emission are turned on. Moreover, when the light emission intensity of LEDs of any one of RGB is low, a white balance is deviated. As a result, it is difficult to obtain visually desired luminance, luminance uniformity and white balance. This leads to a problem that an image is not stably displayed.

To deal with such a problem, an LCD device shown in FIG. 7 has been proposed. This LCD device includes a backlight 100, a backlight control section 106, a photosensor 107, an LCD panel 109 and an LCD driver 108. The backlight control section 106 controls and adjusts light from a backlight source. The photosensor 107 detects the amount of light from the backlight source. In this LCD device, the light emitting area of the backlight source of the backlight 100 is divided into plural areas. In the divided areas, groups of LEDs (hereinafter referred to as LED groups) 101 to 104, are disposed, respectively. The backlight control section 106 is used to turn on the LED groups in the light emitting area except an LED group in one divided area, and to sequentially select and turn off the LED group in each divided area from the plural LED groups in the divided areas. Moreover, the backlight control section 106 controls the amount of light emitted from each of the plural divided areas, according to the output from the photosensor 107. In this way, even when the light emitting characteristics and the amount of light emitted from each LED group of the backlight 100 change, the amount of light emitted from each of the LED groups 101 to 104 is controlled according to the output of the photosensor 107, so that a predetermined amount of light is emitted. Thereby, the luminance uniformity of the backlight 100 is enhanced. Such an LCD device has been proposed in Japanese Patent Laid-Open No. 2005-208486.

However, in the case of the backlight 100 shown in FIG. 7, for a feedback control, the amount of light from the backlight source must be successively detected by the photosensor 107 on the all of the divided area of the LEDs, because the backlight source 100 employs a feedback control. Moreover, in order to adjust the luminance and white balance on all of the divided areas, calculation must be carried out. This results in a problem that the size of the backlight control section 106 becomes large. Furthermore, when the number of divided areas becomes large due to an increase in the size of the backlight 100, the control becomes so complicated that such a large number of divided areas may not be able to be handled.

Moreover, since the distance from the photosensor 107 to each of the LED groups 101 to 104 is different from one another, the amount of light entering the photosensor 107 becomes non-uniform. Consequently, in order to adjust the luminance and chromaticity of each of the LED groups 101 to 104, further correction is required. In addition, when a light guiding path or a condenser is used for making uniform the amount of light entering the photosensor 107, another problem that an extra cost is required also occurs.

### SUMMARY OF THE INVENTION

Accordingly, an exemplary feature of the present invention is to provide a backlight system, an LCD device including the backlight system, and a method of adjusting a backlight, which can simply and securely adjust the amount of light emitted from each LED unit, and can thus achieve favorable white balance with low deviation in color.

A backlight system according to the present invention includes an LED section, a backlight control section, an LED driver section and a photosensor section. The LED section includes plural arrays of LED units each including in each of which LEDs of plural luminescent colors are arranged. The backlight control section outputs an LED drive signal in response to a timing signal. The LED driver section sequentially turns on or off the LED units in response to the LED drive signal. The photosensor section for detecting an amount of light from each of the LED units is disposed on one side of the LED section on an end side of each LED unit in a longitudinal direction thereof. In addition, the photosensor section stores gain correction information corresponding to the position of each LED unit. Moreover, in the photosensor section, a gain used for detecting the amount of light from the LED unit is adjusted on the basis of the gain correction information corresponding to each of the LED units to be adjusted.

It is preferable that only one unit functioning as the photosensor section be disposed. In addition, it is preferable that the photosensor section detect the amount of light from each of the arrays of LED units, by sequentially turning on the LED units. Moreover, it is preferable that the gain be adjusted on the basis of the gain correction information corresponding to the LED unit to be adjusted.

It is preferable that plural units each functioning as the photosensor section be disposed, corresponding respectively to the arrays of LED units. In addition, it is preferable that the photosensor sections detect amounts of light from the respective LED units, by turning on the LED units. Moreover, it is preferable that the gain be adjusted on the basis of the gain correction information corresponding to the LED unit to be adjusted.

It is preferable that the backlight control section store values of electric currents which run respectively in the LED units, in order to make outputs from the respective photosensor sections approximately equal. In addition, it is preferable that, on the basis of information for determining white balance of a predetermined one of the LED units, and also on the basis of the values of the electric currents, white balances of the other LED units be adjusted.

It is preferable that each of the LED units be divided into plural blocks. In addition, it is preferable that each of the photosensor sections detect an amount of light of each of the blocks of the LED unit, by sequentially turning on the blocks of the LED unit. Moreover, it is preferable that the gain be adjusted on the basis of the gain correction information corresponding to the LED unit to be adjusted.

A liquid crystal display device according to the present invention includes a liquid crystal display panel and a backlight system. The backlight system radiates backlight to the liquid crystal display panel, and is controlled so as to, be turned on or off in synchronization with display of the liquid crystal display panel. In addition, the backlight system includes an LED section, a backlight control section, an LED driver section and a photosensor section. The LED section includes plural arrays of LED units each including in each of which LEDs of plural luminescent colors are arranged. The backlight control section outputs an LED drive signal in response to a timing signal. The LED driver section sequentially turns on or off the LED units in response to the LED drive signal. The photosensor section for detecting an amount of light from each of the LED units is disposed on one side of the LED section on an end side of each LED unit in a longitudinal direction thereof. In addition, the photosensor section stores gain correction information corresponding to the position of each LED unit. Moreover, in the photosensor section, a gain used for detecting the amount of light from the LED unit is adjusted on the basis of the gain correction information corresponding to each of the LED units to be adjusted.

It is preferable that one unit functioning as the photosensor section be disposed. In addition, it is preferable that the photosensor section detect an amount of light from each of the plural arrays of LED units, by sequentially turning on the LED units. Moreover, it is preferable that the gain be adjusted on the basis of the gain correction information corresponding to the LED unit to be adjusted.

It is preferable that plural units each functioning as the photosensor section be disposed, corresponding respectively to the plural arrays of LED units. In addition, it is preferable that the photosensor sections detect amounts of light from the respective LED units, by turning on the LED units. Moreover, it is preferable that the gain be adjusted on the basis of the gain correction information corresponding to the LED unit to be adjusted.

It is preferable that the backlight control section store values of electric currents which run respectively in the LED units, in order to make outputs from the respective photosensor sections approximately equal. In addition, it is preferable that, on the basis of information for determining white balances of a predetermined one of the LED units, and also on the basis of the values of the electric currents, white balances of the other LED units are adjusted.

It is preferable that each of the LED units be divided into plural blocks. In addition, it is preferable that each of the photosensor sections detect an amount of light from each of the blocks of the LED unit, by sequentially turning on the blocks of the LED unit. Moreover, it is preferable that the gain be adjusted on the basis of the gain correction information corresponding to the LED units to be adjusted.

In a method of adjusting a backlight according to the present invention, a backlight system includes an LED section for emitting a backlight and a photosensor section for detecting an amount of light from each of the LED units. The LED section is provided with plural arrays of LED units in each of which LEDs of plural luminescent colors are arranged. Each of the LED units is controlled so as to be turned on or off. The photosensor section is disposed on one side of the LED section, on an end side of each LED unit in a longitudinal direction thereof.

The method includes the steps of: storing, in the photosensor section, gain correction information corresponding to the position of each LED unit; and adjusting a gain of the photosensor section on the basis of the gain correction information corresponding to one of the LED units to be adjusted.

It is preferable that one unit functioning as the photosensor section of the backlight be disposed. In addition, it is preferable that, in the storing step, gain correction information corresponding to the position of each LED unit is stored in the photosensor section. Moreover, it is preferable that, in the adjusting step, a gain of the photosensor section is adjusted on the basis of the gain correction information corresponding to each of the LED units to be adjusted.

It is preferable that plural units each functioning as the photosensor section of the backlight system be disposed, corresponding respectively to plural arrays of LED units. In addition, it is preferable that, in the storing step, gain correction information corresponding to the position of each LED unit is stored in the photosensor section. Moreover, it is preferable that, in the adjusting step, a gain of the photosensor section is adjusted on the basis of the gain correction information corresponding to each of the LED units to be adjusted.

It is preferable that the method further include the steps of: storing the values of electric currents which run respectively in the LED units in the backlight control section, in order to make outputs from the respective photosensor sections approximately equal; and adjusting, on the basis of information for determining white balance of a predetermined one of the LED units, and also on the basis of the values of the electric currents, white balances of the other LED units.

It is preferable that each of the LED units be divided into plural blocks. In addition, it is preferable that, in the adjusting step, each of the photosensor sections detects amounts of light of the respective blocks of the LED unit by sequentially turning on the blocks of the LED unit. Moreover, it is preferable that, in the adjusting step, the gain of the photosensor section is adjusted on the basis of the gain correction information corresponding to each of the LED units to be adjusted.

According to the backlight system, the LCD device including the backlight system, and the method of adjusting a backlight, of the present invention, it is possible to simply and securely adjust light emitted from the LEDs of each LED unit. Moreover, the size of the backlight control section does not become large. Furthermore, an extra cost is not required since another optical element for making uniform the amount of light entering the photosensor is not necessary. As a result, it is possible to achieve favorable white balance with low deviation in color.

This is because of the following reason. A photosensor section, which detects light from each LED unit, is disposed on a side of an LED section including plural LED units in each of which plural luminescent colors are arranged. Then, a gain of the photosensor section is adjusted on the basis of gain correction information which is set in advance according to the position of each LED unit. Thereby, the calibration of the photosensor section can be performed in the most suitable condition.

In addition to that, when the photosensor section is solely disposed in a vicinity of the center of a short side of the LED section, a gain of the photosensor section is adjusted on the basis of gain correction information set in advance according to the position of each LED unit. Thereby, the calibration of the photosensor section can be performed in the most suitable condition.

Moreover, when the plural photosensor sections are disposed respectively in vicinities of the respective LED units on a short side of the LED section, on the basis of the values of electric current to the respective LED units, which are set in advance so that outputs of the respective photo sensors are substantially equal, and also on the basis of information for determining white balance of one LED unit, white balances of the other LED units can be adjusted.

Furthermore, when each of the LED units is divided into plural blocks, a gain of the photosensor section is adjusted on the basis of gain correction information set in advance according to the position of each block. Thereby, a white balance can be adjusted for each block.

### BRIEF DESCRIPTION OF THE DRAWINGS

These and other objects and advantages and further description of the invention will be more apparent to those skilled in the art by reference to the description, taken in connection with the accompanying drawings, in which:

FIG. 1 is a block diagram showing a schematic configuration of an LCD device according to a first exemplary embodiment of the present invention;

FIG. 2 is a view showing a configuration of an LED section and a photosensor section, according to the first exemplary embodiment of the present invention;

FIG. 3 is a circuit diagram showing a configuration of the photosensor section according to the first exemplary embodiment of the present invention;

FIG. 4 is a view showing configurations of an LED section and photosensors, according to a second exemplary embodiment of the present invention;

FIG. 5 is a view showing an operation state of the LED section according to the second exemplary embodiment of the present invention;

FIG. 6 is a view showing another operation state of the LED section according to the second exemplary embodiment of the present invention; and

FIG. 7 is a block diagram showing a schematic configuration of a conventional LCD device.

### DETAILED DESCRIPTION OF THE PREFERRED EMBODIMENTS

In the present invention, in a scan backlight including an LED section provided with plural arrays of LED units in each of which plural LEDs are arranged, a photosensor section is disposed on one side of the LED section. The photosensor section detects the amount of light from LEDs. For example, one photosensor section is disposed in a vicinity of the center of a short side of the LED section. The photosensor section is provided with a function of automatically adjusting a gain according to a position where the corresponding LED unit is turned on. Thereby, the calibration of the photosensor section can be performed in the most suitable condition.

In addition, in the scan backlight, plural photosensor sections, each of which detects light from LEDs, are disposed on one side of the LED section. For example, these photosensor sections are disposed respectively in positions corresponding to the respective LED units, on a short side of the LED section. The plural photosensor sections are adjusted in advance so as to have the same output level in response to the same amount of light. Then, values of electric current of the respective LED units are adjusted and then stored, so that the output levels of the respective photosensor sections become equal to one another. That is, the values of electric current of the respective LED units are adjusted, and then stored, so that light emitted from the respective LED units become equal to one another. The white balance of one of the LED units is adjusted so that a Pulse Width Modulation (PWM) control is performed on the LED units in the same manner.

Moreover, each LED unit is divided into plural blocks, and the electric current value of each block is adjusted so as to be synchronized with that of a block to be the reference. At this time, a gain of the photosensor section is adjusted. Thereby, the difference in electric current value can be reduced even in a block of LED unit positioned far from the photosensor section. That is, an electric current value is adjusted in each block of LED unit regardless of the distance between the block and the photosensor.

These make it possible to provide a scan backlight system having excellent white balance with low deviation in color, since it is possible to simply and securely adjust the luminance and the white balance without enlarging the size of the backlight control section.

### First Exemplary Embodiment

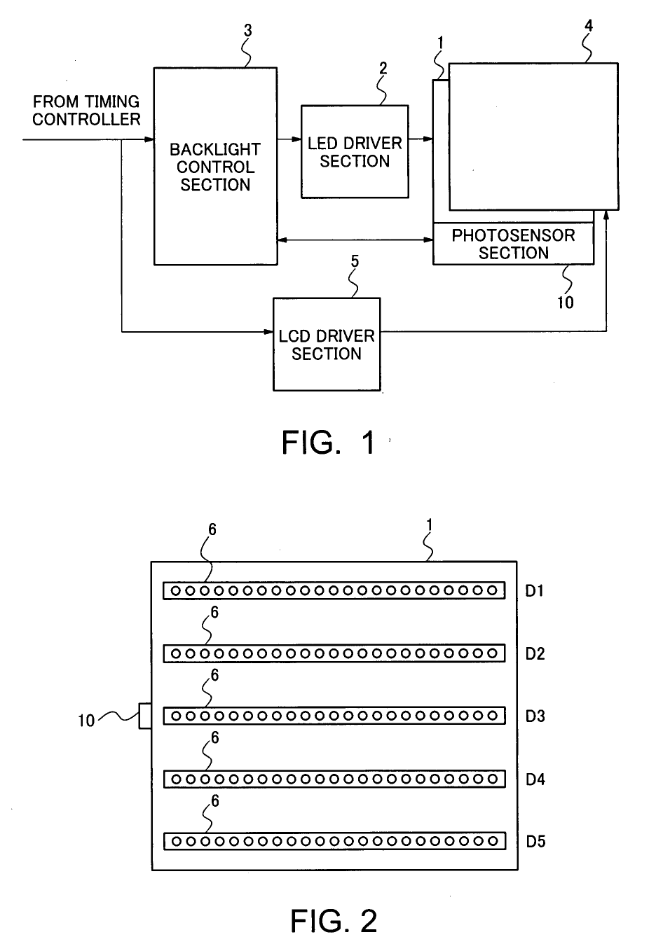

A backlight system, an LCD device including the backlight system, and a method of adjusting a backlight according to a first exemplary embodiment of the present invention are described with reference to FIGS. 1 to 3.

As shown in FIG. 1, a backlight system according to this embodiment includes an LED section 1, an LED driver section 2, a photosensor section 10, a backlight control section 3. The LED section 1 includes plural LEDs. The LED driver section 2 drives the LED section 1. The photosensor section 10 detects light from the LED section 1, and the backlight control section 3 controls the LED driver section 2 and the photosensor section 10. Moreover, an LCD device including the backlight system according to this embodiment includes the LED section 1, the LED driver section 2, the photosensor 10, the backlight control section 3, an LCD panel 4, an LCD driver section 5 and the like. In the LCD panel 4, liquid crystal layer is held between a pair of substrates. The LED driver section 5 drives the LCD panel 4. The drive system of the LCD panel 4, the configuration of switching elements, and the like can be selected as appropriate.

In addition, an unillustrated timing controller supplies signals for driving the LCD device to the LCD driver section 5 and the backlight control section 3. According to the signals, the LCD driver section 5 drives the LCD panel 4. In addition, the backlight control section 3 outputs an LED drive signal to the LED driver section 2. On the basis of the LED drive signal, the LED driver section 2 causes the LED section 1 to emit light in synchronization with the displaying of the LCD panel 4. Moreover, the photosensor section 10 detects light from the LED section 1, converts the detected light into an electric signal, and then sends the electric signal back to the backlight control section 3. In this manner, a feedback loop is established.

Moreover, as shown in FIG. 2, the LED section 1 according to this embodiment is a scan backlight. In the LED section 1, plural arrays of LED units (LED units D1 to D5 in FIG. 2) are arranged. In each LED unit, LEDs 6′ each having plural luminescent colors, such as RGB, are linearly arranged. The LED units D1 to D5 are configured so that the white balance can be adjusted in each LED unit. In this embodiment, only one photosensor section 10, which detects light from the LEDs 6, is disposed in a vicinity of the center of a short side of the LED section 1. In other words, the photosensor section 10 is solely disposed in a vicinity of the center of one side of the LED section 1, on the end side in the longitudinal direction of each LED unit.

FIG. 2 shows a configuration in which five arrays of the LED units are arranged. However, it suffices that the plural LED units are arranged. Moreover, any number of LEDs may be arranged in each LED unit in any manner as appropriate. In FIG. 2, although the photosensor section 10 is positioned on approximately the center of the short side, the photosensor section 10 may not necessarily be positioned on the center. The photosensor section 10 may be disposed on any position of a side of the LED section 1 as long as the photosensor section 10 in the position can detect light from each of the LED units.

Operations of the backlight system configured in the above-described manner and a method of adjusting the backlight are described below. The backlight is adjusted in the following manner. The LED units are sequentially turned on array by array from the LED unit D1 to the LED unit D5, and the light emission of the each LED 6 is adjusted so that every LED unit can have the same white balance. At this time, a gain of the detection sensitivity of the photosensor section 10 is adjusted according to the position of each LED unit, and thereby the calibration of the photosensor section 10 is performed in the most suitable condition.

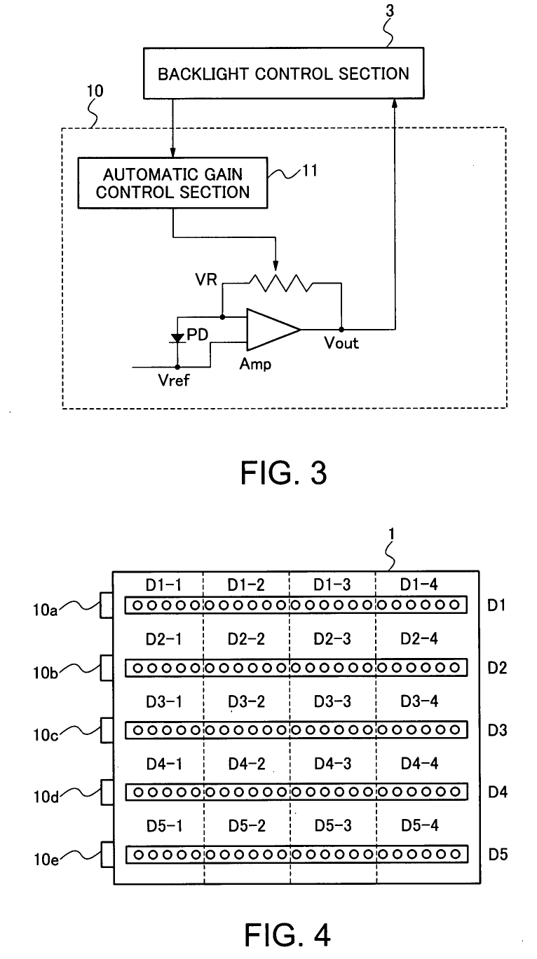

The photosensor section 10 may be configured as shown in FIG. 3, for example. This photosensor section 10 includes an automatic gain control section 11, a differential amplifier Amp, a photodiode PD and a variable resistor VR. The differential amplifier Amp receives a reference voltage Vref through a first input node thereof, and outputs an output voltage Vout through an output node thereof. The photodiode PD is connected between the first input node and a second input node of the differential amplifier Amp. The variable resistor VR is inserted between the second input node and the output node of the differential amplifier Amp, and is controlled by an instruction from the automatic gain control section 11. The output voltage Vout from the differential amplifier Amp is supplied to the backlight control section 3. The photodiode PD is a green photodiode. When the LEDs 6 of the LED units are turned on, the photodiode PD receives light from the LEDs 6, and then becomes conductive. As a result, an electric current runs through the photodiode PD. The current is converted into a voltage according to the resistance of the variable resistor VR and the differential amplifier Amp. Thereby, the voltage corresponding to the amount of light from the LEDs of the LED units is outputted as the output voltage Vout. Then, the output voltage Vout is controlled by the automatic gain control section 11 on the basis of a gain set in the backlight control section 3.

That is, information on gain correction (hereinafter, referred to as gain correction information) corresponding to the position of each LED unit, and to the distance between each LED unit and the photodiode PD is stored in advance in the automatic gain control section 11. The automatic gain control section 11 specifies an LED unit which has been turned on, on the basis of a signal from the backlight control section 3. Then, the automatic gain control section 11 adjusts the gain on the basis of the gain correction information corresponding to the LED unit which has turned on. For example, when light from an LED unit which is far from the photosensor section 10 is detected, the gain of the photosensor section 10 is increased, and when light from an LED unit which is close to the photosensor section 10 is detected, the gain is decreased.

In this manner, the LED section 1 is provided with the plural arrays of LED units which are configured so that the white balance of each LED unit can be adjusted. In addition, one photosensor section 10 is disposed on approximately the center of a short side of the LED section 1. Moreover, gain correction information corresponding to the position of each LED unit is stored in the photosensor section 10. When light from each LED unit is detected, the gain is adjusted on the basis of the gain correction information corresponding to the LED unit. This makes it possible to simply and securely adjust the light emission of each LED while the number of components of the photosensor section 10 is reduced. As a result, it is possible to achieve favorable white balance with low deviation in color.

As described above, the plural LED units D1 to D5 are used, in which the light emission of each LED is adjusted. In addition, the LED units in all of the light emitting areas except one divided area are turned on, and LED units on the one divided area is sequentially selected from among those on plural divided areas to be thereafter turned off. Thereby, regardless of changes in the light emitting characteristics and the amount of emitted light from each LED unit of the LED section 1, the amount of light emitted from each of the LED units D1 to D5 can be controlled to a predetermined amount. As a result, the luminance uniformity of light emitted from the backlight can be enhanced.

### Second Exemplary Embodiment

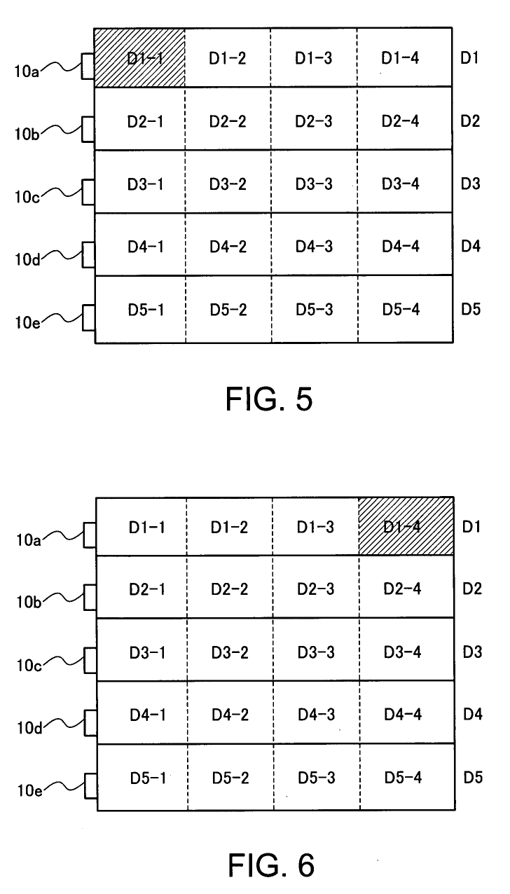

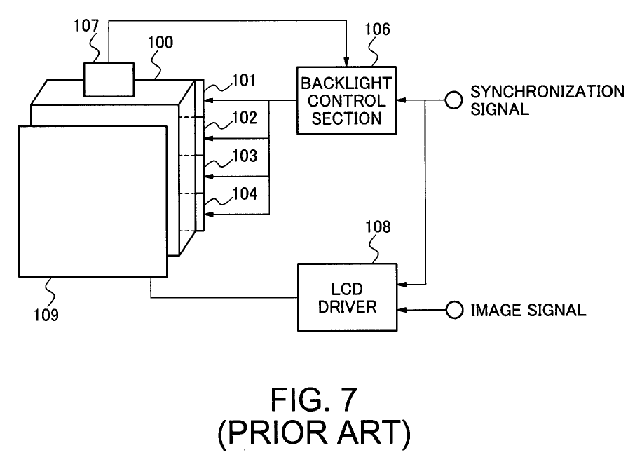

Next, a backlight system, an LCD device including the backlight system, and a method of adjusting a backlight in a second exemplary embodiment of the present invention are described with reference to FIGS. 4 to 6. In the present embodiment, the entire configuration of the backlight system and the details of the photosensor section 10 are the same as those in the first exemplary embodiment shown in FIGS. 1 and 3. Accordingly, the description thereof will be omitted.

In the above-described first exemplary embodiment, one photosensor section 10 is used for plural LED units. On the other hand, in the second exemplary embodiment, as shown in FIG. 4, photosensor sections 10a to 10e are disposed respectively in vicinities of ends of LED units D1 to D5, in a longitudinal direction of each LED unit. In each of the LED units D1 to D5, LEDs of plural luminescent colors such as RGB are linearly arranged. Thereby, the photosensor sections 10a to 10e are configured to detect light emitted from the respective LED units D1 to D5. In addition, each of the LED units D1 to D5 is divided into plural blocks, for example, D1-1, D1-2, D1-3 and D1-4 in the case of the LED unit D1. With this configuration, the blocks in each of LED unit can be separately driven.

Incidentally, in FIG. 4, five arrays of the LED units are provided, and each LED unit is divided into 4 blocks. However, it suffices that there are plural arrays of the LED units, and that there are plural blocks in each LED unit. In addition, outputs of the photosensor sections 10a to 10e are corrected in advance so that the outputs are approximately the same with respect to the same amount of light. Components other than the LED section 1 and the photosensor sections 10a to 10e are the same as those in FIG. 1 of the first exemplary embodiment.

Operations of the backlight system configured in the above-described manner and a method of adjusting a backlight are described. A backlight is adjusted in the following manner. The LED units are, sequentially, turned on array by array from the LED unit D1 to the LED unit D5. Then, light emitted from the LEDs are adjusted so that the LED units D1 to D5 have the same white balance. At this time, electric current is caused to run in each LED unit, and thereby the amount of light is detected using the photosensor sections 10a to 10e corresponding to the respective LED units. In order to make the outputs of the respective photosensor sections 10a to 10e approximately equal, the LED driver section 2 is controlled so that the values of electric currents running in the respective LED units are adjusted. Thereafter, the values of the electric currents are stored in a nonvolatile memory of the backlight control section 3 or the like. Then, after the values of the electric currents for all the RGB are adjusted, a Pulse Width Modulation (PWM) value, which determines white balance, is adjusted, for example, to the photosensor sections 10c positioned in the center, and its output is shared in use. With this configuration, by adjusting the white balance for one LED unit, it is also possible to adjust the white balances for the other LED units.

Moreover, as shown in FIGS. 5 and 6, for example, the LED unit D1 is divided into the four blocks D1-1, D1-2, D1-3 and D1-4. Then, these blocks are separately turned on. The shaded area in each of FIGS. 5 and 6 designates a block which is on. At this time, gains of the detection sensitivity of the photosensor section 10a corresponding to the LED unit D1 are set in the following manner. Specifically, the farther the position of the block emitting light is, the larger the gain of the detection sensitivity of the photosensor section 1a becomes.

Thereby, the same output can be achieved for the same luminance. In other words, the closer to the photosensor section 10a the position of the block emitting light is, the smaller the gain of the detection sensitivity of the photosensor section 10a is set.

That is, as in the case of the first exemplary embodiment, gain correction information corresponding to the position of the block is stored in advance in the automatic gain control section 11. On the basis of a signal from the backlight control section 3, the block of an LED unit, which block is on, is specified. Then, a gain is adjusted on the basis of the gain correction information corresponding to the block of the LED unit, which block is on. For example, when light from a block (D1-1) shown in FIG. 5, which is positioned closest to the photosensor section 10a, is detected, the gain of the photosensor section 10a is reduced. On the other hand, when light from a block (D1-4) shown in FIG. 6, which is positioned farthest from the photosensor section 10a, is detected, the gain of the photosensor section 10a is increased. With this configuration, by adjusting outputs to one of an area to be the reference, it becomes easier to adjust white balances in the peripheral portions, and consequently to reduce non-uniformity in colors. That is, white balance can be adjusted easily not only in the direction of the short side of the LED section 1 but also in the direction of the long side thereof in which divided blocks are arranged. As a result, non-uniformity in color can be reduced.

As described above, the LED section 1 is provided with the plural arrays of LED units, each LED unit being configured so that white balances can be adjusted. In addition, the photosensor sections 10a to 10e are disposed in the vicinities of the ends of the respective LED units in the longitudinal direction. Moreover, in order to obtain approximately the same outputs from the photosensor sections 10a to 10e, the values of electric currents are stored in the backlight control section 3 or the like. Furthermore, information (PWM values and the like) for determining the white balance of one of the plural LED units is applied to the other LED units. Thereby, the emission of light from each LED can be simply and securely adjusted. As a result, it is possible to achieve favorable white balance having low deviation in color.

In addition, each LED unit is divided into plural blocks, and gain correction information corresponding to each block is stored in the photosensor section 10. Moreover, when light from each block is detected, the gain is adjusted on the basis of the gain correction information corresponding to the block. Accordingly, it is possible to adjust the white balance of each block.

In the first exemplary embodiment, described is the case where one photosensor section 10 is provided and the gain is adjusted for each LED unit, on the basis of the gain correction information stored in advance. In the second exemplary embodiment, the following case is described. Specifically, each LED unit is divided into plural blocks, and the photosensor sections 10 are provided to the respective LED units. Thereby, the gain is adjusted for each block on the basis of the gain correction information stored in advance in each photosensor section. However, the present invention is not limited to the above-described embodiments. For example, it is also possible to combine the configurations of the first and second exemplary embodiments. That is, the LED units shown in FIG. 4, each of which includes the plural blocks, can be combined with the one photosensor section 10 shown in FIG. 2, which is disposed in the vicinity of the center of a short side of the LED section 1, for practical use. In this case, by using the one photosensor section 10, light from the blocks of the LED units is detected. For achieving this configuration, gain correction information corresponding to the position of each block is stored in advance. Thereby, using the one photosensor section 10, a gain can be adjusted for each block in each of the plural arrays of LED units. Moreover, the present invention can be applied not only to a backlight system used for an LCD panel, but also to any type of lighting system.

Although preferred embodiments of the invention has been described with reference to the drawings, it will be obvious to those skilled in the art that various changes or modifications may be made without departing from the true scope of the invention.

What is claimed is:

1. A backlight system comprising:
an LED section including plural arrays of LED units each including in each of which LEDs of plural luminescent colors are arranged;
a backlight control section which outputs an LED drive signal in response to a timing signal;
an LED driver section which sequentially turns on or off the LED units in response to the LED drive signal; and
a photosensor section disposed on one side of the LED section on an end side of each LED unit in a longitudinal direction thereof for detecting an amount of light from each of the LED units such that the photosensor section stores gain correction information corresponding to the position of each LED unit, and in which a gain used for detecting the amount of light from the LED unit is adjusted on a basis of the gain correction information corresponding to each of the LED units to be adjusted.

2. The backlight system according to claim 1, wherein
only one unit functioning as the photosensor section is disposed,
the photosensor section detects the amount of light from each of the plural arrays of LED units, by sequentially turning on the LED units, and
the gain is adjusted on the basis of the gain correction information corresponding to the LED unit to be adjusted.

3. The backlight system according to claim 1, wherein
plural units each functioning as the photosensor section are disposed, corresponding respectively to the plural arrays of LED units,
the photosensor sections detect amounts of light from the respective LED units, by turning on the LED units, and
the gain is adjusted on the basis of the gain correction information corresponding to the LED unit to be adjusted.

4. The backlight system according to claim 3, wherein
the backlight control section stores values of electric currents which run respectively in the LED units, in order to make outputs from the respective photosensor sections approximately equal, and
on the basis of information for determining white balance of a predetermined one of the LED units, and also on the basis of the values of the electric currents, white balances of the other LED units are adjusted.

5. The backlight system according to claim 3, wherein
each of the LED units is divided into plural blocks,
each of the photosensor sections detects an amount of light of each of the blocks of the LED unit, by sequentially turning on the blocks of the LED unit, and
the gain is adjusted on the basis of the gain correction information corresponding to the LED unit to be adjusted.

6. The backlight system according to claim 5, wherein
the backlight control section stores values of electric currents which run respectively in the LED units, in order to make outputs from the respective photosensor sections approximately equal, and
on the basis of information for determining white balances of a predetermined one of the LED units, and also on the basis of the values of the electric currents, white balances of the other LED units are adjusted.

7. A liquid crystal display device, comprising:
a liquid crystal display panel; and
a backlight system, which radiates backlight to the liquid crystal display panel, and which is controlled so as to be turned on or off in synchronization with display of the liquid crystal display panel, wherein
the backlight system comprises:
an LED section including plural arrays of LED units in each of which LEDs of plural luminescent colors are arranged;
a backlight control section which outputs an LED drive signal in response to a timing signal;
an LED driver section which sequentially turns on or off the LED units in response to the LED drive signal; and
a photosensor section for detecting an amount of light from each of the LED units, which is disposed on one side of the LED section, on an end side of each LED unit in a longitudinal direction thereof, which stores gain correction information corresponding to each of the LED units, and in which a gain used for detecting the amount of light from the LED unit is adjusted on the basis of the gain correction information corresponding to each of the LED units to be adjusted.

8. The liquid crystal display device according to claim 7, wherein
one unit functioning as the photosensor section is disposed,
the photosensor section detects an amount of light from each of the plural arrays of LED units, by sequentially turning on the LED units, and
the gain is adjusted on the basis of the gain correction information corresponding to the LED unit to be adjusted.

9. The liquid crystal display device according to claim 7, wherein
plural units each functioning as the photosensor section are disposed, corresponding respectively to the plural arrays of LED units,
the photosensor sections detect amounts of light from the respective LED units, by turning on the LED units, and
the gain is adjusted on the basis of the gain correction information corresponding to the LED unit to be adjusted.

10. The liquid crystal display device according to claim 9, wherein
the backlight control section stores values of electric currents which run respectively in the LED units, in order to make outputs from the respective photosensor sections approximately equal, and
on the basis of information for determining white balances of a predetermined one of the LED units, and also on the basis of the values of the electric currents, white balances of the other LED units are adjusted.

11. The liquid crystal display device according to claim 9, wherein
each of the LED units is divided into plural blocks,
each of the photosensor sections detects an amount of light from each of the blocks of the LED unit, by sequentially turning on the blocks of the LED unit, and
the gain is adjusted on the basis of the gain correction information corresponding to the LED units to be adjusted.

12. The liquid crystal display device according to claim 11, wherein
the backlight control section stores values of electric currents which run respectively in the LED units, in order to make outputs from the respective photosensor sections approximately equal, and
on the basis of information for determining white balances of a predetermined one of the LED units, and also on the basis of the values of the electric currents, white balances of the other LED units are adjusted.

13. A method of adjusting a backlight, in which a backlight system includes: an LED section for emitting a backlight, which is provided with plural arrays of LED units each including LEDs of plural luminescent colors arranged therein, and each being controlled so as to be turned on or off; and a photosensor section for detecting an amount of light from each of the LED units, which is disposed on one side of the LED section, on an end side of each LED unit in a longitudinal direction thereof,
the method comprising the steps of:
storing, in the photosensor section, gain correction information corresponding to the position of each LED unit; and
adjusting a gain of the photosensor section on the basis of the gain correction information corresponding to one of the LED units to be adjusted.

14. The method of adjusting a backlight according to claim 13, wherein
one unit functioning as the photosensor section of the backlight is disposed,
in the storing step, gain correction information corresponding to the position of each LED unit is stored in the photosensor section, and
in the adjusting step, a gain of the photosensor section is adjusted on the basis of the gain correction information corresponding to each of the LED units to be adjusted.

15. The method of adjusting a backlight according to 13, wherein
plural units each functioning as the photosensor section of the backlight system are disposed, corresponding respectively to plural arrays of LED units,
in the storing step, gain correction information corresponding to the position of each LED unit is stored in the photosensor section, and
in the adjusting step, a gain of the photosensor section is adjusted on the basis of the gain correction information corresponding to each of the LED units to be adjusted.

16. The method of adjusting a backlight according to claim 15, further comprising the steps of:
storing the values of electric currents which run respectively in the LED units in the backlight control section, in order to make outputs from the respective photosensor sections approximately equal; and
adjusting, on the basis of information for determining white balance of a predetermined one of the LED units, and also on the basis of the values of the electric currents, white balances of the other LED units.

17. The method of adjusting a backlight according to claim 15, wherein
each of the LED units is divided into plural blocks,
in the adjusting step, each of the photosensor sections detects amounts of light of the respective blocks of the LED unit by sequentially turning on the blocks of the LED unit, and
in the adjusting step, the gain of the photosensor section is adjusted on the basis of the gain correction information corresponding to each of the LED units to be adjusted.

18. The method of adjusting a backlight according to claim 17, further comprising the steps of:
storing the values of electric currents which run respectively in the LED units in the backlight control section, in order to make outputs from the respective photosensor sections approximately equal; and
adjusting, on the basis of information for determining white balance of a predetermined one of the LED units, and also on the basis of the values of the electric currents, white balances of the other LED units.
